(19) United States
(12) Patent Application Publication
(10) Pub. No.: US 2022/0230238 A1
(43) Pub. Date: Jul. 21, 2022

(54) SYSTEM AND METHOD FOR ASSESSING RISK

(71) Applicant: PayU Credit B.V., Amsterdam (NL)

(72) Inventors: Piyush Gupta, Mumbai (IN); Prashanth Ranganathan, Mumbai (IN); Rohit Kondapalli, Hyderabad (IN)

(21) Appl. No.: 17/151,771

(22) Filed: Jan. 19, 2021

(51) Int. Cl. G06Q 40/02; G06F 16/901; G06F 16/28; G06F 16/23; G06Q 50/18; G06N 20/00

(52) U.S. Cl. CPC G06Q 40/025; G06F 16/9024; G06N 20/00; G06F 16/2379; G06Q 50/18; G06F 16/285

(57) ABSTRACT

Pursuant to some embodiments, systems, methods and computer program code are provided for operating a service to analyze a request from an applicant (such as a request or application for credit).

### BACKGROUND

Financial institutions frequently are faced with the difficulty of approving or declining financial applications involving applicants that have little to no credit or financial history. Many financial institutions are able to approve or decline financial applications involving applicants that have a credit history, and such decisions are typically made using credit decisioning systems that take credit scores, bureau reports and other payment factors into account. An applicant without a credit history presents a more difficult decisioning problem. It would be desirable to provide improved systems and methods for assessing credit risk for applications involving applicants having little to no credit history or credit scores.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating an application system pursuant to some embodiments.

FIG. 2 is a diagram illustrating a registration method pursuant to some embodiments.

FIG. 3 is a diagram illustrating an application method pursuant to some embodiments.

FIG. 4 is a diagram illustrating of a method of application decisioning pursuant to some embodiments.

FIG. 5 is a diagram illustrating portions of a feature matrix pursuant to some embodiments.

FIG. 6 is a diagram illustrating a computing system for use in the examples herein in accordance with some embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Pursuant to some embodiments, systems, methods, processes and computer program code are provided for operating a service to analyze a request from an applicant (such as a request or application for credit) which includes receiving, a request by the applicant, the request including information identifying the applicant as well as information identifying a plurality of contacts of the applicant, the information identifying a plurality of contacts including at least one of a phone number and an email address associated with each of the plurality of contacts. For each of the plurality of contacts information associated with the contact is accessed to obtain information identifying their interactions with the applicant. A contact graph is generated where the user is the central node of the contact graph and each of the plurality of contacts are neighbor nodes of the central node. In some embodiments, the graph is then extended such that a plurality of contacts of the neighbor nodes are added to the graph. For those contacts of the neighbor nodes, information associated with those contacts may be accessed to obtain information identifying their interactions with the neighbor node. The graph may be further extended (such that further layers of neighbor nodes and their contacts are added to the graph). Aggregate graph level features for the contact graph are then generated and features about the graph (as well as features about the applicant, such as banking information, location information, etc.) are provided as an input to a classification model to classify the request. Embodiments allow the accurate and efficient classification of applications for credit even where the applicant has no prior credit history.

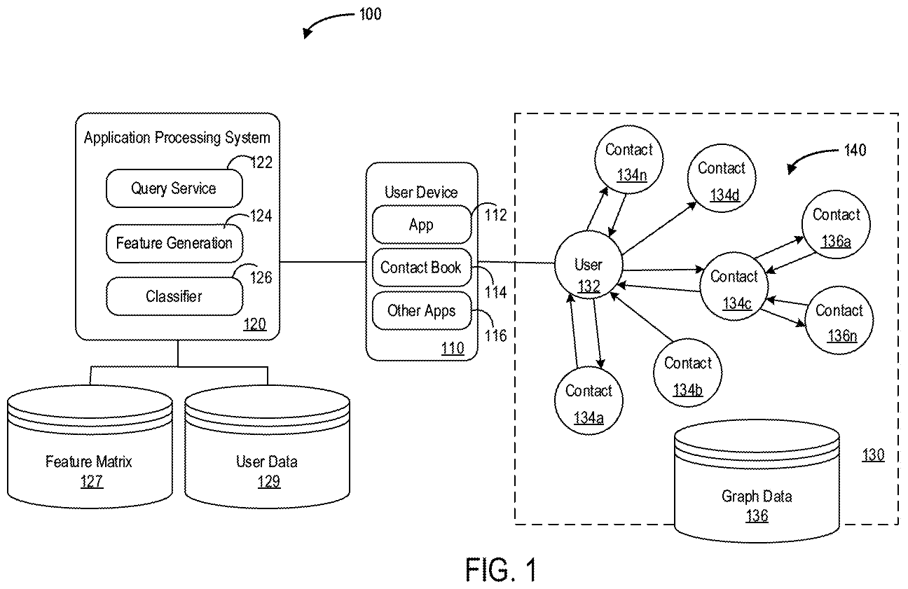

Features of some embodiments will be described by first referring to FIG. 1 which depicts a system 100 pursuant to some embodiments of the present invention. As shown, the system 100 includes an application processing system 120 in communication with a user 132 operating a user device 110 to interact with a software application 112. In an illustrative embodiment used to describe features of some embodiments, the software application 112 is a mobile application and the user device 110 is a mobile phone or other mobile device. Embodiments may be used in conjunction with other types of devices such as, for example, desktop computers or the like. Further, the software application 112 may be an application hosted on a remote computer device (such as, for example, a web server associated with the application processing system 120) and the software application 112 may be accessed by a user 132 interacting with the software application 112 via a Web browser (not shown) of the user device 110.

The user 132 interacts with an application processing system 120 via the user device 110 and the software application 112. The software application 112 may interact with other applications 116 or components installed on or associated with the user device 110. For example, in some embodiments, the software application 112 may access a phone call log to identify different phone calls made or received by the user device 110. As another example, the software application 112 may access location information associated with locations visited by the user device 110. As a further example, the software application 112 may access information associated with messages sent or received by the user 132 via the user device 110 (such as SMS messages or application messages associated with applications such as WeChat or the like). This information (as well as information from one or more contact books associated with the user device 110 as described further below) may be used to generate feature data for a feature matrix which will be described further below.

The software application 112 may be, for example, a mobile application maintained and distributed by or on behalf of an entity operating the application processing system 120 (e.g., such as an iPhone or an Android application). The software application 112 may serve a number of functions in addition to allowing a user 132 to submit an application for credit pursuant to the present invention. For example, the software application 112 may also allow the user 132 to interact with other users or participants in the network 130 (e.g., in the example where the network 130 is a financial network, the user 132 may interact with the software application 112 to perform funds transfer transactions involving other users in the network 130).

The user device 110 may communicate with the application processing system 120 via a network such as a cellular network, the Internet or the like. Communication between the user device 110 and user devices of other participants in the network 130 may be via similar networks or via direct communications such as via Bluetooth or other wireless connections. While only user device 110 (associated with user 132) is shown in communication with application processing system 120, in practical application, some or all of the users in the network 130 may interact with the application processing system 120 (as well as with other users) via other user devices.

As shown in FIG. 1, the user 132, the contacts and interactions between the user 132 and contacts of the user 132 (shown as contacts 134a-n) as well as contacts of those contacts 134a-n (shown as contacts 136a-n) may be represented as participants in a network 130. Some or all of the participants in the network 130 may also be participants in a payment system (such as a system that allows users to send or receive funds transfers and apply for credit using the application processing system 120 of the present invention). Pursuant to some embodiments, some or all of the participants of the network 130 may operate user devices (similar to, for example, the user device 110) and may have contact books 114 and interaction data similar to the data discussed herein with respect to the user 132 and user device 110. Pursuant to some embodiments, some or all of the participants in the network 130 may grant access or permissions to an operator of the application processing system 120 to analyze and obtain contact data and other interaction data as described herein.

In this manner, participants in the network 130 may authorize a system operator to access information about their contacts, allowing the creation of a contact graph in the event that a user wishes to apply for credit using features of the present invention. In some embodiments, some of the participants in the network 130 may be participants in one or more communication networks or a social media networks and the contacts of a user may be other users or participants of that network. For illustration, the network 130 will be described herein as being a directed graph network in that may include one or more degrees of separation from a user 132.

A graph database 136 is shown as being associated with the network 130. In practical application, the graph database 136 may be stored at or otherwise accessible to the application processing system 120 and stores information about a plurality of node graphs or networks. For example, for each user that wishes to apply for credit using the system of the present invention, a node graph associated with the user's network 130 may be created. The node graph data 136 may include information identifying the user 132 as well as information defining the graph structure of the network 130. In some embodiments, the node graph is a directed graph which includes a set of objects (or “nodes”) that are connected together as depicted in FIG. 1. Each of the connected nodes have a direction of connection (where the connections may be referred to as “edges”). For example, the edges between user 132 and contact 134a include one that is directed from the contact 134a to the user 132 (referred to herein as an “in-connection” from the perspective of the user 132) as well as an edge that is directed from the user 132 to the contact 134a (referred to herein as an “out-connection” from the perspective of the user 132).

The nodes that are one degree of separation from the user 132 may be referred to as “DOS-1” nodes or “neighbor” nodes. Pursuant to some embodiments, the network 130 of a user 132 may be generated to include nodes that are two or more degrees of separation from the user 132. Pursuant to some embodiments, by including such DOS-2+ nodes, embodiments are able to achieve greater accuracy in credit decisioning as will be described further herein.

Pursuant to some embodiments, each participant of the network 130 may have an account with a network service provider (or other entity managing the network 130). For simplicity and ease of exposition, the application processing system 120 will be generally referred to herein as the entity managing the network 130 as well as the entity that performs application processing pursuant to the present invention. In practical application, the application processing system 120 may be different than the system managing the network 130 and may be operated by the same or different entities.

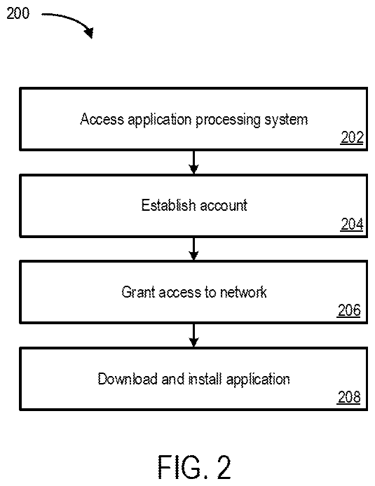

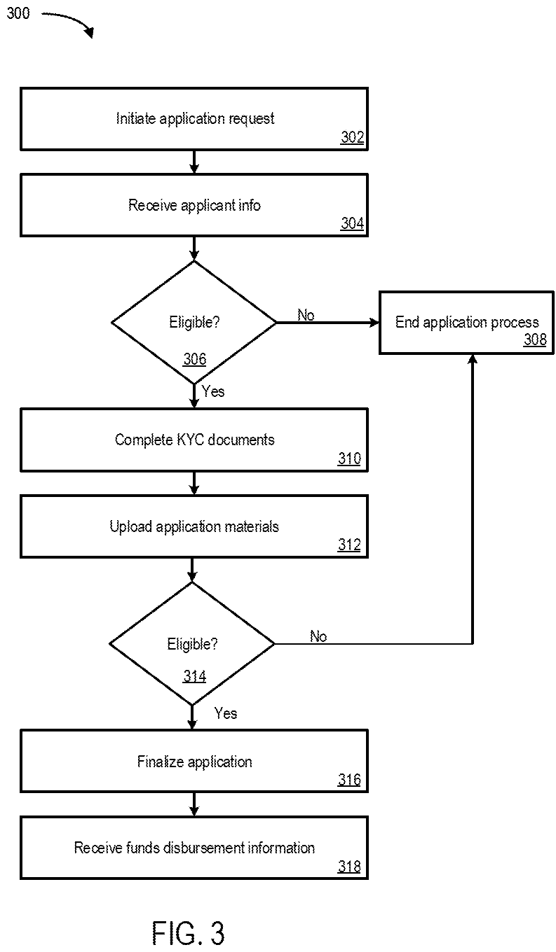

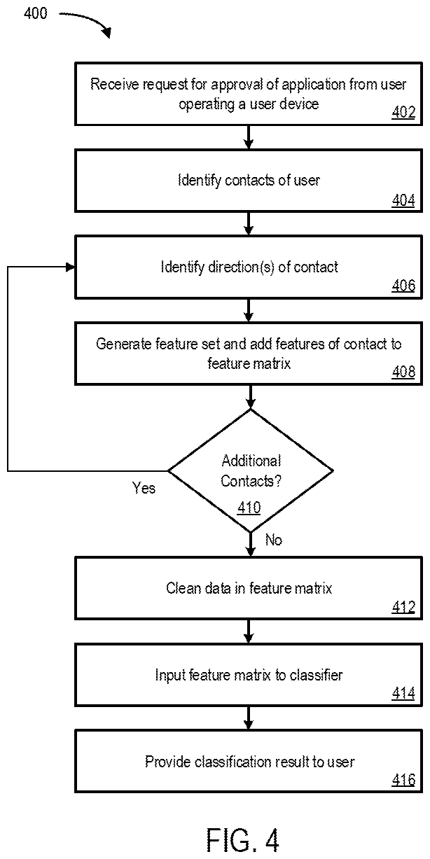

The application processing system 120 may include a number of modules or applications including, for example, a query service 122, a feature generation service 124 and a classifier 126. The application processing system 120 also includes (or is in communication with) the graph database 136. Pursuant to some embodiments, a graph or network processing module may be provided at the application processing system 120 to generate graph data for a user 132 for storage in a graph database 136. These modules or applications may be embedded within a software application or a combination of software modules that are running on a hardware device such as a server, a database, a cloud platform, a user device, or the like. In some embodiments, the query service 122, the feature generation service 124, and the classifier 126 may be replaced with or otherwise controlled by a processor such as a hardware processing device. In some embodiments, the application processing system 120 may also include one or more user interface modules or applications that allow a user 132 operating a user device 110 to interact with one or more user interfaces hosted by the application processing system 120. For example, one or more user interfaces may be provided to allow a user to register to participate in the network as described in conjunction with FIG. 2. As another example, one or more user interfaces may be provided to allow a user to submit an application for decisioning as described in conjunction with FIGS. 3 and 4, etc.

Pursuant to some embodiments, the application processing system 120 interacts with one or more data stores including, for example, a feature matrix data store 127 and a user data store 129. The user data store 129 includes information associated with the user 132 as well as information associated with contacts of that user 132. As illustrated in FIG. 1, the user 132 has a contact graph 140 that includes a number of contacts 134a-n in the network 130 as well as one or more contacts 138 outside of the network 130. The contact data of the user 132 may be stored in the user data store 129 or it may be downloaded or obtained from the contact book 114 of the user device 110 associated with the user 132. In some embodiments, the contact data may include information such as the number of times a contact has been contacted, as well as a duration and mode of each contact.

Pursuant to some embodiments, the contact graph 140 of the user 132 is an egocentric contact graph in which the user 132 is the central node and all of the contacts of the user 132 are neighbor nodes. Further, the contact graph 140 is a directed graph such that each of the connections between the nodes of the graph has a direction. For example, the relationship between the user 132 and contact 134a is a two-way connection indicating that user 132 has contact information (such as a phone number or email address, etc.) of contact 134a in a contact book 114 of the user device 110 (which may be a native contact book 114 of the device 110 or it may be a module associated with the software application 112, for example) and that contact 134a has contact information of user 132 in a contact book of a user device (not shown) associated with contact 134a. For example, if the user 132 has a phone number of contact 134a in contact book 114, then the edge connection between the nodes is an “out-connection” originating at user 132 and terminating at 134a. Similarly, if the phone number of user 132 is present in the contact book of contact 134a, then a further edge connection between the two nodes is present (an “in-connection” for the user 132). An “in-connection” for the user 132 is also an “out-connection” from the perspective of the contact 134. In some embodiments, creation of the contact graph may also include obtaining contact data from each of the nodes of the contact graph. For example, the following data may be collected from each of the direct connections of user 132: demographic data, SMS data, location data, information associated with the number of times the contact has interacted with the user as well as the duration and mode of each contact, credit bureau data, credit performance data, social network data, mobile device usage data, mobile application interaction data, and financial data. As will be discussed further below in conjunction with FIG. 4, this information is used to generate a feature matrix for use in classifying the application of the user 132.

Pursuant to some embodiments, other data (in addition to the contact data) may be obtained from the user device 110 for use in processing applications pursuant to the present invention. For example, in some embodiments, the application processing system 120 may also download or otherwise obtain information associated with the user 132 such as: personally identifiable information, demographic data, text messages and other SMS data (e.g., including financial and non-financial SMS data, but preferably excluding personal SMS data), banking data (if any), and location data (such as global positioning system or “GPS” data).

In some embodiments, in addition to identifying edges or connections between users and contacts using direct connections as described above, some edges or connections may be inferred or predicted. For example, in some embodiments, the network may be enhanced by creating additional edges between users even if there is no explicit edge between the users through the contact methods described above. Such edge predictions may be made using either local or global techniques. Edges or connections may further be generated between users based on a particular property or attribute. Fore example, if a user's network (such as the network 130 for user 132) includes users who are not directly connected to user 132 (but are connected to user 132's neighbors, such as contacts 136), an edge may be created between those remote neighbors to improve the connection quality. In such an example, an edge may be inferred between user 132 and contacts 136.

Although not shown in FIG. 1, each of the contacts in the contact graph 140 are given one or more labels. For example, labels may include: (i) labels based on a degree of closeness between the contact and the user, (ii) labels based on a customer status or a participation status in the network 130, (iii) labels based on historical credit performance (e.g., such as performance in past loans or other financial transactions), or (iv) labels based on affluence, geographical location, job-type or relationship.

Pursuant to some embodiments, the labels based on a degree of closeness may be determined by checking a number of parameters. For example, if a user 132 has saved information about a contact using one or more common words associated with a familial relationship (“dad”, “papa’, “mom”, “uncle”, “sis”, etc.), that contact may be used to indicate a degree of closeness. Further, a similarity measure may be applied to surname matches, and that similarity measure may be used in conjunction with a count of times the contact has been contacted (and, in some embodiments, the duration of those contacts) to indicate a closeness of the relationship. Further, location information may be used to determine if a contact resides in the same location as the user. These labels based on degrees of closeness can improve the feature matrix and provide desirable results. Other relationship labels may be provided to indicate a relationship of employee/employer or the like.

Pursuant to some embodiments, the labels based on a customer status or a participation status in the network 130 may based on comparing information about the contact with information in a user database 129 associated with the application processing system 120. For example, contact 134a may have already applied for (and been approved or declined for) a loan by submitting an application to the application processing system 120 (or by otherwise applying for credit from an entity associated with the application processing system 120). Details of such an application (and the outcome) may be used in generating a feature matrix including that contact information as will be described further below.

Pursuant to some embodiments, the labels based on historical credit performance may be obtained from credit bureaus and/or from the application processing system 120 data. Details of such prior credit may be used in generating the feature matrix as will be described further below. In general, the data associated with the different contacts in the directed graph 140 as well as the label data is used to generate a feature matrix which is then used as data to be input to a machine learning classifier 126 to classify an application of a user 132 as either approved or declined. The feature matrix data store 127 stores information associated with a user 132 and the user's network 140 (as well as feature data associated with that network). Feature data are a set of explanatory variables (i.e., “features”) that are used as inputs to a machine learning classifier engine (such as the classifier 126). The feature data for a given user's application may vary based on the network associated with the user 132.

The use of this collected data to generate a feature matrix for application to a classifier will be described further below. In general, however, embodiments allow a large number of features or variables to be identified and aggregated for each user who applies for credit using the present invention. This allows a highly detailed feature matrix to be generated with thousands of features that can then be used as an input to a classifier. The result is a highly accurate prediction of a user's credit risk—allowing applications to be approved or declined with a high degree of confidence.

While only a single user device 110 and application processing system 120 are shown in FIG. 1, those skilled in the art will appreciate that in use there will be a number of devices in use, a number of users submitting applications and potentially multiple instances of the application processing system in operation. Further, users 132 and contacts 134, 136 can interact with multiple devices. Pursuant to some embodiments, data from multiple devices may be tracked and attributed to each user or contact so that the data may be used when generating the network and the feature matrix. For example, a user may interact with a mobile device as well as a laptop or desktop computer. Data from each of those devices may be associated or attributed to the user so that contact data associated with either device will be used when generating the network and feature matrix. As will be described further below, application decisioning transactions conducted using embodiments of the present invention have a number of desirable advantages over existing approaches. For example, embodiments allow risk to be quantitatively identified even for users who have no prior credit (or even banking) history.

FIG. 2 illustrates a registration process 200 that may be performed by a user 132 operating a user device 110 to register for participation in the system of the present invention prior to submitting a financial application. Data collected or provided in association with the process 200 may be stored at or be accessible to one or more databases associated with the application processing system 120 (e.g., such as the user data store 129).

The registration process 200 of FIG. 2 begins when a user first (at 202) interacts with a registration server (which may be a component of, or related to, application processing system 120 of FIG. 1) to initiate a registration process. For example, the user may operate an Internet browser (either on a mobile device or another computing device) to access a registration Web page associated with the registration server. The registration Web page may request the user provide some identifying information to begin the account creation process. For example, a user may provide name, address and other contact information as well as contact preferences, including one or more email addresses and phone numbers. A user identifier or other unique record (or records) may be established on behalf of the user in a database such as the user data store 129.

Processing continues at 204 where the user establishes an account. In some embodiments, the account creation includes providing contact and identifying information associated with the user, as well as information identifying one or more user device(s) from which the user wishes to make transactions. Each user device 110 may, for example, be identified by its phone number and/or other unique identifier(s) (such as a hardware serial number, an ASIN, a UUID, a component serial number such as a CPU serial number or the like). In some embodiments, where the user registers from a browser on their mobile device, or by first downloading a mobile application having a registration module onto their mobile device, the system may capture unique identifying information associated with the mobile device (e.g., such as a hardware serial number, an ASIN, a UUID or other device identifiers).

Once the account has been established, in some embodiments, processing continues at 206 where the user is prompted to allow the application (and the application processing system 120) to access the user's list of contacts (e.g., obtained from the contact book 114 and/or any social network or other application data 116). This permission allows the application processing system 120 to establish an egocentric graph of the user when needed to perform application processing (as will be described further below in conjunction with a discussion of FIG. 4). This consent may be granted at 206 or it may be granted earlier (e.g., when the user initially interacted with the registration server or web pages). Processing continues at 208 where a download of the application is completed and the mobile application is installed on the user device 110 for use by the user. In some embodiments, the application may have functions other than for submitting a loan application or other request for credit. For example, the application may be associated with a funds transfer service that allows a user to transfer or send funds from an account of the user to an account of another user in the network 130. The application may have a further feature or function allowing a user to submit an application for credit as will be described in conjunction with FIGS. 3 and 4.

Reference is now made to FIG. 3, where a method 300 of submitting an application for decisioning is shown pursuant to some embodiments. For example, the method 300 may be performed by interaction between the user 132, the user device 110, the software application 112 and the application processing system 120. In general, the method 300 may be initiated by a user 132 who wishes to submit an application for credit. The method 300 may be performed after the user 132 performs a registration process such as the registration process 200 of FIG. 2. After the user 132 has completed the registration process, the user 132 may choose to request credit from an entity operating or associated with the application processing system 120 of FIG. 1. The request for credit may be performed using a process such as the method 300 of FIG. 3.

The method 300 begins at 302 where the user 132 interacts with the software application 112 of the user device 110 to initiate an application request. For example, the user 132 may navigate to or open a user interface associated with the software application 112 to begin an application for credit. At 304 the user 132 may be prompted to enter applicant information including, for example, information usable by the application processing system 120 to properly identify the user 132. The information provided at 304 may include information such as the user's full name, address, date of birth, country identifier (such as a social security number in the U.S. or equivalent in other countries). Some or all of this information may have previously been provided by the user 132 during a software application installation process such as the process 200 of FIG. 2. This information is provided to the application processing system 120 which may create a credit application record for the user 132.

Processing continues at 306 where the application processing system 120 performs an initial credit eligibility check. In some embodiments, processing at 306 includes executing a model pursuant to the present invention to determine if the user 132 is eligible for credit (even in situations where the user 132 has no credit history or credit score). More particularly, processing at 306 may be performed using the process 400 of FIG. 4 discussed further below. If the classification result returned at the end of process 400 is an indication that the user 132 is not eligible, processing continues at 308 and the application process is ended. For example, the software application 112 may present a user interface to the user 132 indicating that the user's request for credit has been denied.

If the classification result returned at the end of process 400 is an indication that the user 132 is eligible, processing continues at 310 and the user 132 is prompted to upload or otherwise provide the application processing system 120 with one or more identification documents to allow the application processing system 120 to perform “know your customer” or “KYC” processing. For example, the user 132 may be prompted to scan, upload or take a photo of a driver's license or other identification documents.

Processing continues at 312 where the user 132 may be prompted for additional financial documents. In some embodiments, the type of documents to be provided by the user 132 may depend on the nature of the credit application (e.g., an application requesting a large amount of credit may require additional documentation). For example, the user 132 may be prompted to upload, scan or otherwise provide financial documents for one or more months (e.g., where the financial documents may include bank statements or the like). The application processing system 120 may convert any received financial documents to text for further processing. More particularly, in some embodiments, the financial data provided by a user 132 is used to generate user-level features for use in the classification model.

In some embodiments, an additional step is performed at 314 where the classification model and processing of FIG. 4 is performed again. This time, the process 400 is performed using the additional user-level features obtained based on the financial documentation received at 312. Applicants have found that the additional user-level features provide additional accuracy in performing the classification of an application.

If processing at 314 is performed and the classification indicates that the user is not eligible, processing continues at 308 and the application process is ended. Again, the user 132 may be presented with a user interface indicating that the credit application has been declined.

If processing at 314 is performed and the classification indicates that the user is eligible, processing continues at 316 and the credit application is finalized. The user 132 may be presented with the terms and conditions of the credit to be extended and the user 132 may interact with the software application 112 to accept (or refuse) the terms. Processing continues at 318 where the user 132 receives funds disbursement information and the process ends.

Pursuant to some embodiments, the eligibility determination is performed using a classification model that is based on aggregate graph level features from a contact graph as well as user-level features based on information about the user. The classification is performed using a process such as the process of FIG. 4.

FIG. 4 illustrates a method 400 of application decisioning pursuant to some embodiments. For example, the method 400 may be performed by a database node, a cloud platform, a server, a computing system (user device), a combination of devices/nodes, or the like. The method 400 begins at, for example, 402 where the application processing system 120 receives a request for approval of an application from a user operating a user device (such as user 132 and user device 110). For example, the request received at 402 may be received by the user interacting with an application webform hosted by or on behalf of the application processing system 120. The application may be, for example, a credit application in which the user 132 requests that an entity (such as, for example, the entity operating the application processing system 120) extend credit to the user 132. The application may include information associated with the credit request such as the amount requested, the term of the loan, etc. The application may also include the user's consent to allow the application processing system 120 to access and use the user's contact information as well as to access other information associated with the user 132 and the user's contacts. In some embodiments, processing at 402 may also include making a determination that the user 132 does not have a credit history. For example, in some embodiments, if the user 132 already has a credit history, processing of FIG. 4 may terminate and a different application decisioning process may be performed (e.g., such as one in which standard credit decisioning is used). However, in some embodiments, processing may continue even if the user 132 has a credit history. In such embodiments, the credit history information may be augmented with information from the feature graph associated with the user. In this way, embodiments provide greater accuracy in arriving at credit decisions even for users having a credit history.

Processing continues at 404 where the application processing system 120 operates to identify contacts of the user 132. For example, processing at 404 may include accessing the contact book 114 of the user device 110 or otherwise obtaining information from the contact book 114. Data from the contact book 114 may be stored in a user data store 129 for further processing and for use in creation of a feature matrix 127. In some embodiments, processing at 404 further includes accessing other information from the user device 110 (including, for example, location data, demographic data, SMS and phone contact data, email histories, etc.). Processing continues at 406 where a loop is entered in which each contact of the user 132 is analyzed. Processing at 406 includes analyzing a contact 134 of the user 132 to determine the direction(s) of contact with that contact 134. In general, any contact of the user 132 from the user's contact book will be an “out-connection”. “In-connections” will be identified once the user's network is traversed (e.g., when the user 132 is a contact in a contact's 134 contact book, the connection is an “in-connection” to the user 132 and an “out-connection” to the contact 134). This information can be determined, for example, by analyzing phone contact history, SMS messages, and email messages involving communication between the user and the contact. Information about the connection is used to create a directed graph involving the contact 134 and the user 132.

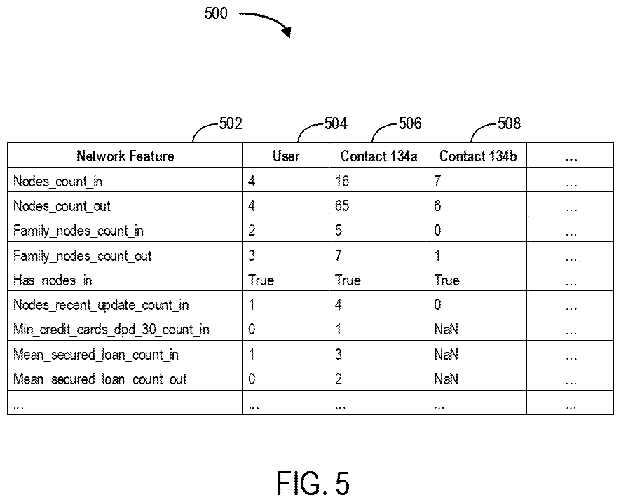

Processing continues at 408 where, for the current contact, a feature set is generated and the resulting feature data is added to a feature matrix for the user. In some embodiments, the type of features that may be identified for a contact may depend on whether the contact is a network contact, a bureau contact or both. For example, features associated with a contact that has a credit history (e.g., a “bureau” contact) may include features associated with that credit history (features like a count of loans outstanding, a max amount of loans outstanding, an amount of days past due for different loans, a bureau score, etc.). As another example, features associated with a contact that does not have a credit history but is a participant in a network (such as the network 130 of FIG. 1) may include features associated with contacts (such as a count of nodes in, a count of nodes out, a count of family nodes in a count of family nodes out, etc.) as well as features associated with financial performance or history of those contacts (such as a count of nodes that have loans, a count of nodes that have credit cards, a sum of balances, etc.). For each contact in the user's contact graph, the relevant feature matrixes are applied to information about the contact to add information to a feature matrix being generated for the user. An illustrative example of portions of a feature matrix is shown in FIG. 5. In this illustrative example, the feature matrix 500 includes a number of network features 502 as well as feature data for the user 504 as well as contacts of that user 506, 508. In practical application, the feature matrix 500 would have thousands of features 502 as well as a data for each of the user's contacts.

As shown in the illustrative example in FIG. 5, the features include a number of types of data including counts of attributes (like a count of in and out nodes, etc.). Pursuant to some embodiments, the feature set may include multi-level features or “deep” features. The use of deep features from the network allows the system to extract and identify more information for a user. A deep feature allows stacking of one feature on another. For example, a deep feature may include three levels where the first level is a count of in/out connections. The second level may be a MAX/MIN/SKEW of the number of unsecured accounts in the network. A third level may be the SKEW/MAX of an average disbursal amount for unsecured accounts for all network users where the network direction is “in”. In some embodiments, a tool such as the tool provided at http://www.featuretools.com may be used to generate additional deep features for use in the feature matrix. In general, applicants have found that having additional features allows for improved accuracy when performing a classification pursuant to the present invention.

Once the features of the current contact have been added to the feature matrix, processing continues at 410 where a determination is made whether any additional contacts exist in the user's contact graph. If so, processing repeats at 406 for the next contact in the user's contact graph. If not, processing continues to 412 where the data in the feature matrix is cleaned (if needed). As shown in the example matrix 500 of FIG. 5, some feature data may not be available for certain contacts (represented as nulls or “NaN” entries). As an illustrative but not limiting example, in some embodiments, if a feature has more than approximately 80% nulls or zeros, then that data may be replaced with default values. If a feature has more than approximately 98% zero values or 95% nulls, then those features may be dropped from the matrix. Other data cleansing may be performed to ensure that the data is ready for processing.

Once the feature matrix is ready for classification, processing continues at 414 where the data of the feature matrix is inputted to a machine learning classification engine (such as the classifier 126 of FIG. 1). In some embodiments, the classification is a binary class classification (intended to classify the application as “approve” or “decline”). Embodiments may utilize a suitable binary class classifier. Applicants have found that the XGBoost classifier produces desirable results and is particularly suitable as it is a decision-tree based algorithm that works well with smaller training datasets and a high number of features. Another suitable classifier is the LightGBM classifier which is another tree-based learning algorithm; in general, any classifier (including neural networks) may be used.

The results of the classifier are provided to the user at 416 (such as an approval or a decline). For example, the results may be presented to the user 132 via the software application 112 on the user device 110. Embodiments provide desirable and accurate results. For example, for users who are not new to credit (e.g., users that have an existing credit history and score), classification using the approach described herein provides credit decisioning results that are similar to those provided by traditional credit decisioning approaches that are score-based. Even further improved results may be achieved by using both a traditional credit decisioning approach and a network based approach as described herein.

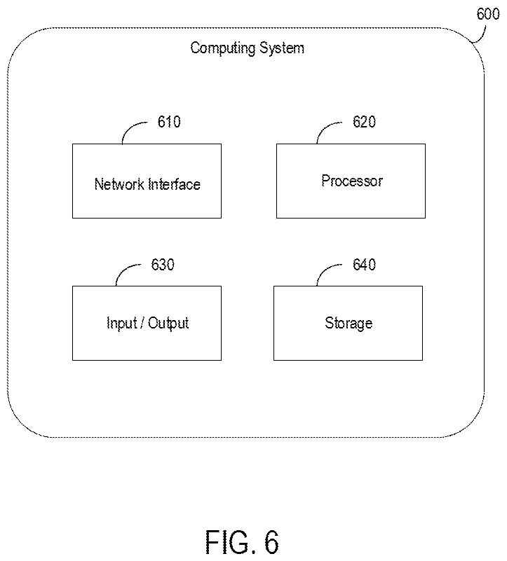

FIG. 6 illustrates a computing system 600 that may be used in any of the methods and processes described herein, in accordance with an example embodiment. For example, the computing system 600 may be a database node, a server, a cloud platform, or the like. In some embodiments, the computing system 600 may be distributed across multiple computing devices such as multiple database nodes. Referring to FIG. 6, the computing system 600 includes a network interface 610, a processor 620, an input/output 630, and a storage device 640 such as an in-memory storage, and the like. Although not shown in FIG. 6, the computing system 600 may also include or be electronically connected to other components such as a display, an input unit(s), a receiver, a transmitter, a persistent disk, and the like. The processor 620 may control the other components of the computing system 600.

The network interface 610 may transmit and receive data over a network such as the Internet, a private network, a public network, an enterprise network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The input/output 630 may include an interface, a port, a cable, a bus, a board, a wire, and the like, for inputting and outputting data to and from the computing system 600. For example, data may be output to an embedded display of the computing system 600, an externally connected display, a display connected to the cloud, another device, and the like. The network interface 610, the input/output 630, the storage 640, or a combination thereof, may interact with applications executing on other devices.

The storage device 640 is not limited to a particular storage device and may include any known memory device such as RAM, ROM, hard disk, and the like, and may or may not be included within a database system, a cloud environment, a web server, or the like. The storage 640 may store software modules or other instructions which can be executed by the processor 620 to perform the methods shown in FIGS. 2-4. According to various embodiments, the storage 640 may include a data store that stores data in one or more formats such as a multidimensional data model, a plurality of tables, partitions and sub-partitions, and the like. The storage 640 may be used to store database records, items, entries, and the like.

According to various embodiments, the processor 620 may be configured to identify feature data associated with a contact in a contact graph by operating a query service 122 to query data associated with contacts in a contact graph. The processor 620 may further be configured to generate a feature matrix and present that feature matrix to a classifier 126 for classification. In general, the processor 620 may be configured to perform any of the functions outlined above. The storage 640 may be configured to store the feature matrix in a feature matrix data store 127.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A method for operating a service to analyze a request from an applicant, the method comprising:
receiving, a request by the applicant, the request including information identifying the applicant as well as information identifying a plurality of direct contacts of the applicant, the information identifying a plurality of direct contacts including at least one of a phone number and an email address associated with each of the plurality of direct contacts;
accessing, for each of the plurality of direct contacts, information associated with those direct contacts to obtain information identifying their interactions with the applicant;
generating a contact graph where the applicant is the central node of the contact graph and each of the plurality of direct contacts are neighbor nodes of the central node;
generating user-level features for the applicant; and
generating aggregate graph level features for the contact graph and providing the aggregate graph level features and the user-level features as inputs to a classification model to classify the request.

2. The method of claim 1, wherein classifying the request includes classifying the request as one of an approval and a decline.

3. The method of claim 1, wherein each of the connections between the neighbor nodes and the central node has a direction.

4. The method of claim 1, further comprising:
identifying, for at least a first direct contact of the plurality of direct contacts, a plurality of secondary contacts of the at least first direct contact; and
updating the contact graph where each of the plurality of secondary contacts are neighbor nodes of the at least first direct contact.

5. The method of claim 4, wherein each of the connections between the neighbor nodes has a direction.

6. The method of claim 1, further comprising:
assigning one or more labels to each of the nodes in the contact graph.

7. The method of claim 1, further comprising:
for each of the neighbor nodes, collecting feature data associated with the contact.

8. The method of claim 6, wherein the labels include labels based on one or more of (i) the closeness of a relationship between the applicant and a contact, (ii) a count of contacts from the plurality of contacts that are users of the service, (iii) a count of contacts that have a good credit history, and (iv) a count of contacts that have a poor credit history.

9. The method of claim 8, wherein the closeness of the relationship is inferred based at least in part on at least one of (i) a familial label of the contact in a contact book of the applicant, (ii) a similarity of a surname shared with the applicant, and (iii) shared location information associated with the contact and the applicant.

10. The method of claim 7, wherein collecting feature data associated with the contact further comprises:
collecting, for the contact, at least one of (i) demographic data, (ii) SMS data, (iii) location data, (iv) count of contacts, (v) duration of contacts, (vi) mode of contact, (vii) credit bureau data, and (viii) performance data.

11. The method of claim 1, wherein the user-level features are based at least in part on financial documents submitted by the applicant associated with the request.

12. A system, comprising:
a communication device to receive a request to process an application for credit from a user device and to transmit a response to the user device;
a processor coupled to the communication device; and
a computer storage device in communication with the processor and storing instructions adapted to be executed by the processor to:
receive the application for credit, the application including information identifying an applicant as well as information identifying a plurality of direct contacts of the applicant, the information identifying a plurality of direct contacts including at least one of a phone number and an email address associated with each of the plurality of direct contacts;
access, for each of the plurality of direct contacts, information associated with those direct contacts to obtain information identifying their interactions with the applicant;
generate a contact graph where the user applicant is the central node of the contact graph and each of the plurality of direct contacts that are users of the service are neighbor nodes of the central node; and
generate aggregate graph level features for the contact graph and providing the aggregate graph level features as an input to a classification model to classify the request.

13. The system of claim 12, further comprising instructions adapted to be executed by the processor to:
generate user-level features for the applicant and provide the user-level features as further inputs to the classification model to classify the request.

14. The system of claim 12, wherein the request is classified as one of an approval of the application for credit and a decline of the application for credit.

15. The system of claim 12, further comprising instructions adapted to be executed by the processor to:
identify, for at least a first direct contact of the plurality of direct contacts, a plurality of secondary contacts of the at least first direct contact; and
update the contact graph where each of the plurality of secondary contacts are neighbor nodes of the at least first direct contact.

16. The system of claim 15, further comprising instructions adapted to be executed by the processor to:
infer a connection between the applicant and at least one of the plurality of secondary contacts.

17. A non-transitory, computer-readable medium storing instructions, that, when executed by a processor, cause the processor to perform a method to analyze a request for credit from an applicant, the method comprising:
receiving the application for credit, the application including information identifying an applicant as well as information identifying a plurality of direct contacts of the applicant, the information identifying a plurality of direct contacts including at least one of a phone number and an email address associated with each of the plurality of direct contacts;
accessing, for each of the plurality of direct contacts, information associated with those direct contacts to obtain information identifying their interactions with the applicant;
generating a contact graph where the user applicant is the central node of the contact graph and each of the plurality of direct contacts that are users of the service are neighbor nodes of the central node; and
generating aggregate graph level features for the contact graph and providing the aggregate graph level features as an input to a classification model to classify the request.

18. The medium of claim 17, wherein the request is classified as one of an approval of the request for credit and a decline of the request for credit.

19. The medium of claim 17, further comprising:
generating user-level features for the applicant and providing the user-level features as further inputs to the classification model to classify the request.

20. The medium of claim 17, further comprising:
assigning one or more labels to each of the nodes in the contact graph.
